(19) United States
(12) Patent Application Publication
(10) Pub. No.: US 2016/0183313 A1
(43) Pub. Date: Jun. 23, 2016

(54) MECHANISM TO SELECT APPROPRIATE S2a CONNECTIVITY MODE FOR TRUSTED WLAN

(71) Applicant: INTEL CORPORATION, SANTA CLARA, CA (US)

(72) Inventors: Venkata R. VALLABHU, ALOHA, OR (US); Vivek GUPTA, San Jose, CA (US); Necati CANPOLAT, Beaverton, OR (US)

(21) Appl. No.: 14/581,248

(22) Filed: Dec. 23, 2014

(51) Int. Cl. H04W 76/02

(52) U.S. Cl. CPC H04W 76/02; H04W 84/12

(57) ABSTRACT

Techniques for presenting S2a connection mode options in a WLAN environment are provided. Specifically, methods are presented, that when taken alone or together, provide a device or group of devices with an efficient way of selecting the appropriate connectivity mode for use with an S2a interface. The present disclosure includes a method that provides a wireless device with network connectivity options that enable a more effective means for obtaining Trusted WLAN attachment.

### TECHNICAL FIELD

Embodiments pertain to wireless networks. Some embodiments relate to wireless networks that operate in accordance with one of the Institute of Electrical and Electronics Engineers (IEEE) 802.11 standards including the IEEE 802.11-2012 standards. Some embodiments relate to access to a communication network. Some embodiments relate to the association between a user equipment (UE) and a Wireless Local Area Network (WLAN).

### BACKGROUND

As wireless devices are becoming more ubiquitous and consumers are in constant demand for wireless connectivity, the wireless industry has had to rapidly innovate efficient ways to provide consumers with the connection access they desire. A major obstacle in achieving this is the limited availability of radio frequency spectrum. A solution that has been proposed to achieve greater spectrum efficiency is to offload the communication between two or more networks. For example, in the 3GPP technical specification, the interworking between a 3GPP network and a WLAN network has been added. This interworking has introduced the ability to offload from a 3 G or 4 G network operating in accordance with the 3GPP standards to a WLAN operating in accordance with IEEE 802.11 standards in order to provide additional bandwidth.

As the 3GPP technical specification has evolved, trusted network access has been added with the use of an S2a interface. Trusted network access may occur using one of three different connectivity modes: 1) Transparent Single-Connection Mode, 2) Single-Connection Mode, and Multi-Connection Mode. However, these connection modes are known to clients only after Authentication and Key Agreement (AKA) with the WLAN AP has occurred, i.e., post association. As such, the client may end up selecting an unsuitable WLAN Network to connect to if information regarding mode availability is not available to the client prior to association.

A number of issues are arising from this scenario. One such issue is that the client would need to restart the association process, if the 3GPP network does not support the mode that the client connected to and associated with. Another issue includes the need for re-authentication each time a new mode is tried. Still another issue is the frustration introduced to the user as connectivity is being stalled. It is with these and other considerations that the present improvements have been developed.

The 802.11 standard specifies a common Medium Access Control (MAC) Layer which provides a variety of functions that support the operation of 802.11-based wireless LANs (WLANs). The MAC Layer manages and maintains communications between 802.11 stations (such as between radio network cards (NIC) in a PC or other wireless devices or stations (STA) and access points (APs)) by coordinating access to a shared radio channel and utilizing protocols that enhance communications over a wireless medium.

802.11n introduced in 2009, improved maximum single-channel data rate from 54 Mbps of 802.11g to over 100 Mbps. 802.11n also introduced MIMO (multiple input/multiple output), where, according to the standard, up to 4 separate physical transmit and receive antennas carry independent data that is aggregated in a modulation/demodulation process in the transceiver.

The IEEE 802.11ac specification operates in the 5 GHz band and adds channel bandwidths of 80 MHz and 160 MHz with both contiguous and non-contiguous 160 MHz channels for flexible channel assignment. 802.11 ac also adds higher order modulation and supports multiple concurrent downlink transmissions (“multi-user MIMO” (MU-MIMO)), which allows transmission to multiple spatial streams to multiple clients simultaneously. By using smart antenna technology, MU-MIMO enables more efficient spectrum use, higher system capacity and reduced latency by supporting up to four simultaneous user transmissions. 802.11 ac streamlines the existing transmit beamforming mechanisms which significantly improves coverage, reliability and data rate performance.

IEEE 802.11 ax is the successor to 802.11 ac and is proposed to increase the efficiency of WLAN networks, especially in high density areas like public hotspots and other dense traffic areas. 802.11 ax will also use orthogonal frequency-division multiple access (OFDMA). Related to 802.11 ax, the High Efficiency WLAN Study Group (HEW SG) within the IEEE 802.11 working group is considering improvements to spectrum efficiency to enhance system throughput/area in high density scenarios of APs (Access Points) and/or STAs (Stations).

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary communication system using a 3GPP network;

FIG. 2 illustrates an exemplary wireless device;

FIG. 3 illustrates an exemplary access point;

FIG. 4 illustrates an exemplary ANQP Protocol Information ID Definitions Table;

FIG. 5A illustrates an exemplary format of an ANQP element;

FIG. 5B illustrates a Generic WLAN container;

FIG. 5C illustrates an exemplary Information Element (IE) with S2A connectivity modes;

FIG. 5D illustrates an exemplary embodiment of IE with Voice over Wi-Fi (VoWiFi) support;

FIG. 6 illustrates an exemplary embodiment of Information Element Identities (IEI);

FIG. 7 illustrates a fence-post diagram showing an exemplary message flow in a network access system;

FIG. 8 illustrates a fence-post diagram showing an exemplary method for trusted attachment between a wireless device and a WLAN; and

FIG. 9 is a flowchart illustrating trusted WLAN association.

### DESCRIPTION OF EMBODIMENTS

Embodiments may be implemented as part of Wi-Fi Alliance® Technical Committee Hotspot 2.0 Technical Task Group Hotspot 2.0 (Release 2) Technical Specification, Version 2.04, Jan. 2, 2013. Embodiments may also be implemented as part of the 3GPP TS 23.402, 3GPP TR 23.852, and 3GPP TS 24.244 Technical Specification. Embodiments are implemented as part of the 3GPP TS23.402 Technical Specification regarding Architecture enhancements for non-3GPP accesses including but not limited to the interworking between E-UTRAN and CDMA200 and Between 3GPP Access and WiMAX and the use of S2b/S2a interface. Embodiments are implemented as part of the 3GPP TR 23.852 Study on S2a Mobility based on GPRS Tunnelling Protocol (GTP) and Wireless Local Area Network (WLAN) access to the Enhanced Packet Core (EPC) network (SaMOG) including solutions for GTP based S2a and considerations for WLAN access to EPC through S2a. Embodiments are implemented as part of the 3GPP TS 24.302 Access to the 3GPP Evolved Packet Core including but not limited to trusted and untrusted access. However, the embodiments are not limited to 802.11 standards, Hotspot 2.0, or 3GPP S2a standards. Embodiments can be used in implementation with other wireless communications standards and the like.

In the following detailed description, numerous specific details are set forth in order to provide a thorough understanding of the disclosed techniques. However, it will be understood by those skilled in the art that the present embodiments may be practiced without these specific details. In other instances, well-known methods, procedures, components and circuits have not been described in detail so as not to obscure the present disclosure.

Although embodiments are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, a communication system or subsystem, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, circuits, or the like.

Before undertaking the description of embodiments below, it may be advantageous to set forth definitions of certain words and phrases used throughout this document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, interconnected with, contain, be contained within, connect to or with, couple to or with, be communicable with, cooperate with, interleave, juxtapose, be proximate to, be bound to or with, have, or the like; and the term “controller” means any device, system or part thereof that controls at least one operation, such a device may be implemented in hardware, circuitry, firmware or software, or combination of at least two of the same. It should be noted that the functionality associated with any particular controller may be centralized or distributed, whether locally or remotely. Definitions for certain words and phrases are provided throughout this document and those of ordinary skill in the art should understand that in many, if not most instances, such definitions apply to prior, as well as future uses of such defined words and phrases.

The exemplary embodiments will be described in relation to communications systems, as well as protocols, techniques, means and methods for performing communications, such as in a wireless network, or in general in any communications network operating using any communications protocol(s). Examples of such are home or access networks, wireless home networks, wireless corporate networks, and the like. It should be appreciated however that in general, the systems, methods and techniques disclosed herein will work equally well for other types of communications environments, networks and/or protocols.

For purposes of explanation, numerous details are set forth in order to provide a thorough understanding of the present techniques. It should be appreciated however that the present disclosure may be practiced in a variety of ways beyond the specific details set forth herein. Furthermore, while the exemplary embodiments illustrated herein show various components of the system collocated, it is to be appreciated that the various components of the system can be located at distant portions of a distributed network, such as a communications network, node, and/or the Internet, or within a dedicated secured, unsecured, and/or encrypted system and/or within a network operation or management device that is located inside or outside the network. As an example, a wireless device can also be used to refer to any device, system or module that manages and/or configures or communicates with any one or more aspects of the network or communications environment and/or transceiver(s) and/or stations and/or access point(s) described herein.

Thus, it should be appreciated that the components of the system can be combined into one or more devices, or split between devices, such as a transceiver, an access point, a station, a Domain Master, a network operation or management device, a node or collocated on a particular node of a distributed network, such as a communications network. As will be appreciated from the following description, and for reasons of computational efficiency, the components of the system can be arranged at any location within a distributed network without affecting the operation thereof.

Furthermore, it should be appreciated that the various links, including the communications channel(s) connecting the elements can be wired or wireless links or any combination thereof, or any other known or later developed element(s) capable of supplying and/or communicating data to and from the connected elements. The term module as used herein can refer to any known or later developed hardware, circuitry, software, firmware, or combination thereof, that is capable of performing the functionality associated with that element. The terms determine, calculate, and compute and variations thereof, as used herein are used interchangeable and include any type of methodology, process, technique, mathematical operational or protocol.

Moreover, while some of the exemplary embodiments described herein are directed toward a transmitter portion of a transceiver performing certain functions, this disclosure is intended to include corresponding and complementary receiver-side functionality in both the same transceiver and/or another transceiver(s), and vice versa.

Presented herein are embodiments of systems, processes, data structures, user interfaces, etc. The embodiments may relate to a communication device and/or communication system. The communication system can include a Trusted WLAN connection. A trusted WLAN connection can include communication and association between two or more networks or network devices. The overall design and functionality of the system described herein is, as one example, to provide a more efficient means for a device to attach to a different network using an S2a interface with one or more connectivity modes.

Embodiments provide novel networking mechanisms that facilitate a fast and efficient process for locating connectivity modes prior to network association. The embodiments generally reduce or remove the need for a client to associate more than one time in order to identify the appropriate connectivity mode supported by the 3GPP network. As a result, a faster and less cumbersome connection is achieved while improving user experience by decreasing connection time. Other advantages exist as well as will be discussed herein.

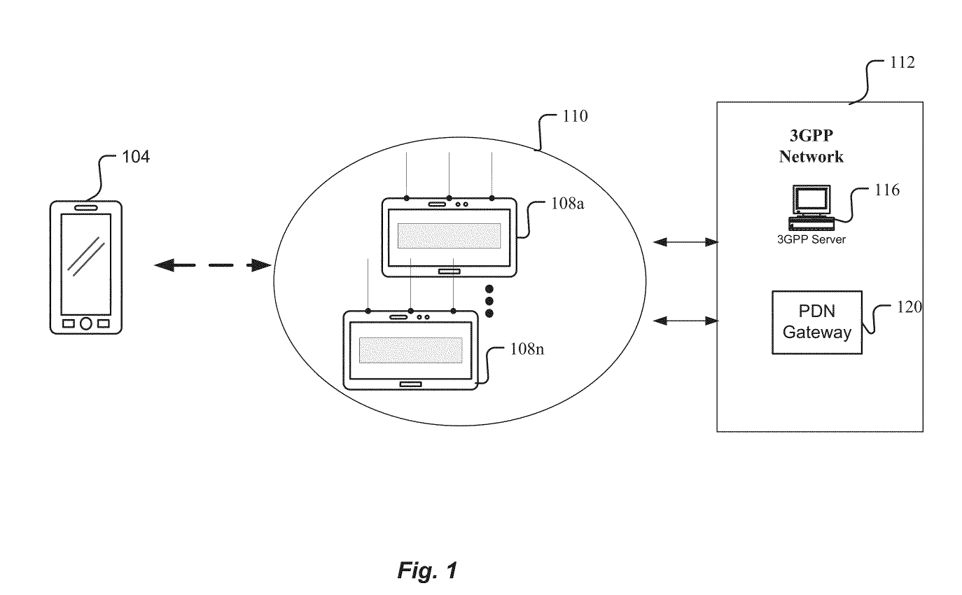

A general communication system using a 3GPP network is shown in FIG. 1. The communication system can contain various devices which work together to provide connectivity over a 3GPP network. In general, various techniques and configurations are available for a wireless device 104 to attach to 3GPP Enhanced Packet Core (EPC) network 112 using WLAN as a Trusted WLAN Access Network (TWAN) 110.

The TWAN 110 can include one or more access points 108a-108n which can work together, or independently of an access controller (not shown) to help establish the network access via the TWAN 110. In one example, the TWAN 110 can include a WiFi network operating in accordance with one or more of the IEEE 802.11 standards.

Various methods exist for attaching to a 3GPP EPC. For example, a wireless device 104 operating in accordance with 3GPP standards can attach to the WiFi network using at least a Packet Data Network Gateway (PDN-GW) 120. An S2a interface can be used for the exchange of information between the access points 108-108n and the PDN-GW 120. In another example, the wireless device 104 can attach using a 3GPP Server 116, such as a 3GPP Authentication, Authorization, and Accounting (AAA) Server via a STa interface.

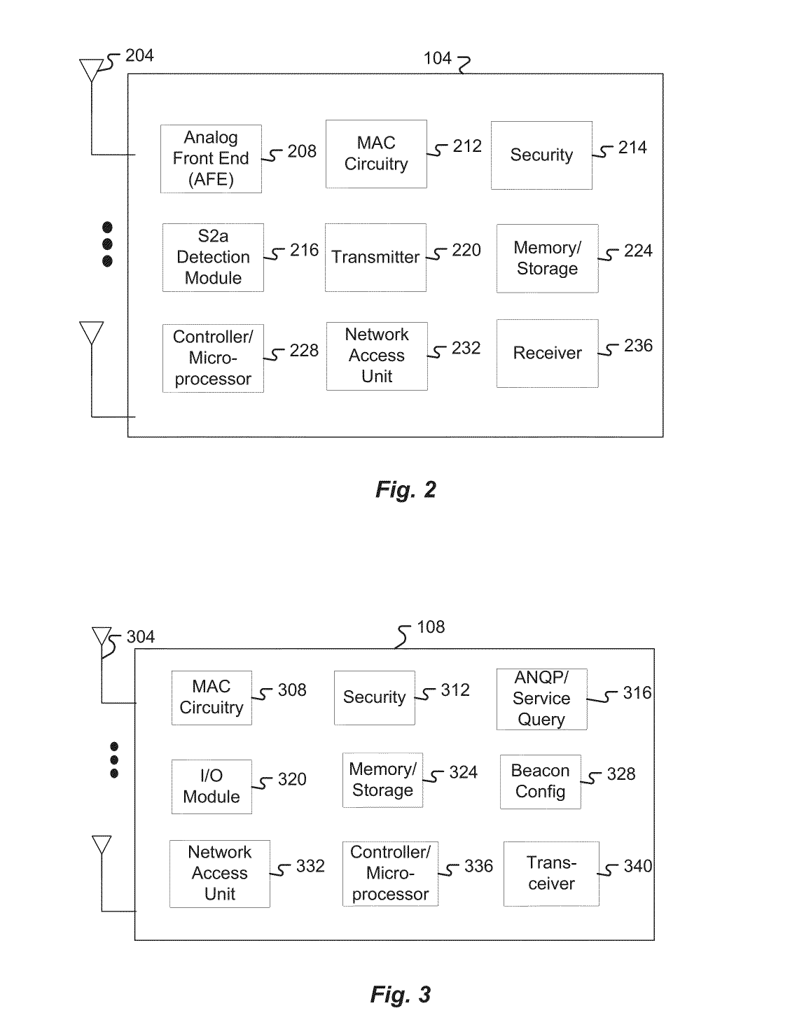

An example of a wireless device 104 architecture is shown in FIG. 2. The wireless device 104 may comprise hardware circuitry and/or software that conduct various operations. The operations can include, but are not limited, to conducting calls, synchronizing with access points 108, opening multiple applications, presenting information through audio and/or video means, taking pictures, communicating via a trusted WLAN, etc. The wireless device 104 can be any type of computing system operable to conduct the operations described here. As an example, the wireless device 104 can be a mobile phone which includes and interacts with various modules and components 208-236 as shown in FIG. 2.

The wireless device 104 can have one more antennas 204, for use in wireless communications such as multi-input multi-output (MIMO) communications, Bluetooth®, etc. The antennas 204 can include, but are not limited to directional antennas, omnidirectional antennas, monopoles, patch antennas, loop antennas, microstrip antennas, dipoles, and any other suitable for communication transmission. In an exemplary embodiment, transmission using MIMO may require particular antenna spacing. In another exemplary embodiment, MIMO transmission can enable spatial diversity allowing for different channel characteristics at each of the antennas. In yet another embodiment, MIMO transmission can be used to distribute resources to multiple users.

Antennas 204 generally interact with an Analog Front End (AFE) module 208, which is needed to enable the correct processing of the received modulated signal. The AFE 208 can sit between the antenna and a digital baseband system in order to convert the analog signal into a digital signal for processing.

The wireless device 104 can also include a controller/microprocessor 228 and a memory/storage 224. The wireless device 104 can interact with the memory/storage 224 which may store information and operations necessary for configuring and transmitting or receiving the message frames described herein. The memory/storage 224 may also be used in connection with the execution of application programming or instructions by the controller/microprocessor 228, and for temporary or long term storage of program instructions and/or data. As examples, the memory/storage 224 may comprise a computer-readable device, RAM, ROM, DRAM, SDRAM or other storage devices and media.

The controller/microprocessor 228 may comprise a general purpose programmable processor or controller for executing application programming or instructions related to the wireless device 104. Further, controller/microprocessor 228 can perform operations for configuring and transmitting message frames as described herein. The controller/microprocessor 228 may include multiple processor cores, and/or implement multiple virtual processors. Optionally, the controller/microprocessor 228 may include multiple physical processors. By way of example, the controller/microprocessor 228 may comprise a specially configured Application Specific Integrated Circuit (ASIC) or other integrated circuit, a digital signal processor, a controller, a hardwired electronic or logic circuit, a programmable logic device or gate array, a special purpose computer, or the like.

The wireless device 104 can further include a transmitter 220 and receiver 236 which can transmit and receive signals, respectively, to and from other wireless devices 104 or access points 108 using one or more antennas 204. Included in the wireless device 104 circuitry is the medium access control or MAC Circuitry 212. MAC circuitry 212 provides the medium for controlling access to the wireless medium. In an exemplary embodiment, the MAC circuitry 212 may be arranged to contend for a wireless medium and configure frames or packets for communicating over the wireless medium. The MAC circuitry 212 can work together or independently of the S2a detection module 216, which can aid in identifying S2a enabled access points 108. The S2a detection module 216, can but is not limited to, providing a wireless device 104 with a prompt announcing the existence of an AP 108 in the vicinity with S2a mode selection options, providing the AP 108 with user ID information for connecting to a Trusted Wireless LAN, communicating with a 3GPP server 116 or other communication device, responding to Access Network Query Protocol (ANQP) and other service queries, etc.

The wireless device 104 can also contain a security module 214. This security module 214 can contain information regarding but not limited to, security parameters required to connect the wireless device 104 to AP 108 or other available networks, and can include WEP or WPA security access keys, network keys, etc. The WEP security access key is a security password used by Wi-Fi networks. Knowledge of this code will enable the wireless device 104 to exchange information with the access point 108. The information exchange can occur through encoded messages with the WEP access code often being chosen by the network administrator. WPA is an added security standard that is also used in conjunction with network connectivity with stronger encryption than WEP.

Another module that the wireless device 104 can include is the network access unit 232. The network access unit 232 can be used for connectivity with the access point 108. In one exemplary embodiment, the connectivity can include synchronization between devices. In another exemplary embodiment, the network access unit 232 can work as a medium which provides support to the S2a detection module 216 for connecting to a Trusted WLAN. In yet another embodiment, the network access unit 232 can work in conjunction with at least the MAC circuitry 212. The network access unit 232 can also work and interact with one or more of the modules described herein.

The modules described and others known in the art can be used with the wireless device 104 and can be configured to perform the operations described herein in conjunction with FIG. 1 and FIGS. 3-9.

An example of access point 108 architecture is shown in FIG. 3. The access point 108 may comprise hardware and/or software that conduct various operations. The operations can include, but are not limited, to broadcasting S2a mode connection options, providing a medium for communication between a wireless device 104 and a 3GPP network 112, synchronizing with wireless devices 104, providing hotspot identification, etc. The access point 108 can be any type of computing system operable to conduct the operations described here. As an example, the access point 108 can be a router which includes and interacts with various modules and components 308-340 as shown in FIG. 3.

The access point 108 can have one more antennas 304, for use in wireless communications such as multi-input single-output (MISO), single-input multi-output (SIMO), MIMO or the like. The antennas 304 can include, but are not limited to directional antennas, omnidirectional antennas, monopoles, patch antennas, loop antennas, microstrip antennas, dipoles, and any other suitable for communication transmission. In an exemplary embodiment, transmission using MIMO may require particular antenna spacing. In another exemplary embodiment, MIMO transmission can enable spatial diversity allowing for different channel characteristics at each of the antennas. In yet another embodiment, MIMO transmission can be used to distribute resources to multiple users.

The access point 108 can also include a controller/microprocessor 336 and a memory/storage 324. The access point 108 can interact with the memory/storage 324 which may store information and operations necessary for configuring and transmitting or receiving the message frames described herein. The memory/storage 324 may also be used in connection with the execution of application programming or instructions by the controller/microprocessor 336, and for temporary or long term storage of program instructions and/or data. As examples, the memory/storage 324 may comprise a computer-readable device, RAM, ROM, DRAM, SDRAM or other storage devices and media.

The controller/microprocessor 336 may comprise a general purpose programmable processor or controller for executing application programming or instructions related to the access point 108. Further, controller/microprocessor 336 can perform operations for configuring and transmitting beacons as described herein. The controller/microprocessor 336 may include multiple processor cores, and/or implement multiple virtual processors. Optionally, the controller/microprocessor 336 may include multiple physical processors. By way of example, the controller/microprocessor 336 may comprise a specially configured Application Specific Integrated Circuit (ASIC) or other integrated circuit, a digital signal processor, a controller, a hardwired electronic or logic circuit, a programmable logic device or gate array, a special purpose computer, or the like.

An input/output (I/O) module 320 can also be part of the AP 108 architecture. The input/output module 320 and associated ports may be included to support communications over wired or wireless networks or links. For example, I/O module 320 can provide communication with wireless devices 104, servers, communication devices, and/or peripheral devices. Examples of an input/output module 320 include an Ethernet port, a Universal Serial Bus (USB) port, Institute of Electrical and Electronics Engineers (IEEE) port 1394, or other interface.

The access point 108 can further include a transceiver 340 which can transmit and receive signals to and from other wireless devices 104 or access points 108 and/or the Internet using one or more antennas, 204 and 304 respectively, and/or hard-wired links (not shown). Included in the AP 108 architecture is the medium access control or MAC circuitry 308. MAC circuitry 308 provides the medium for controlling access to the wireless medium. In an exemplary embodiment, the MAC circuitry 308 may be arranged to contend for a wireless medium and configure frames or packets for communicating over the wireless medium. The MAC circuitry module 308 can work together or independently of a network access unit 332, which can aid in broadcasting to the S2a mode enabled wireless devices 104 and connecting to them. In one exemplary embodiment, the connectivity can include synchronization between devices. The network access unit 332 can also work and interact with one or more of the modules described herein.

The beacon configuration module 328 can also part of the access point architecture 108, and can but is not limited to, allocating information in a beacon frame for broadcasting to one or more wireless devices 104. Beacon configuration can include allocating information to one or more of the beacon header, body and tail. Among the information included in a beacon frame is the beacon interval, SSID of the AP 108, S2a mode support, and destination address. The beacon can also provide both the wireless device 104 ANQP and other similarly developed service discovery query information. The beacon configuration module 328 thus, interacts with an ANQP/Service query module 316. The ANQP/Service query module 316 can hold instructions detailing the services offered by the AP 108. This module can also host the information needed to provide the wireless device 104 with details regarding the connectivity modes available, Network Address Identifiers, Emergency Alert System messages, etc. The ANQP/Service query module 316 is not limited to ANQP query information; this module can be used independently, in conjunction with, or in addition to other modules with similarly developed service discovery query information.

Access point 108 can also contain a security module 312. This security module 312 will contain information regarding, but not limited to, security parameters required to connect the wireless device 104 to AP 108 or other available networks, and can also include WEP or WPA security access keys, network keys, etc. The WEP security access key is a security password used by Wi-Fi networks. Knowledge of this code will provide the wireless device 104 with access to exchange information with the access point 108. The information exchange can occur through encoded messages and WEP access code is often chosen by the network administrator. WPA is an added security standard that is also used in conjunction with network connectivity with stronger encryption than WEP.

The modules described and others known in the art can be used with the access point 108 and can be configured to perform the operations described herein and in conjunction with FIGS. 1-2 and FIGS. 4-9.

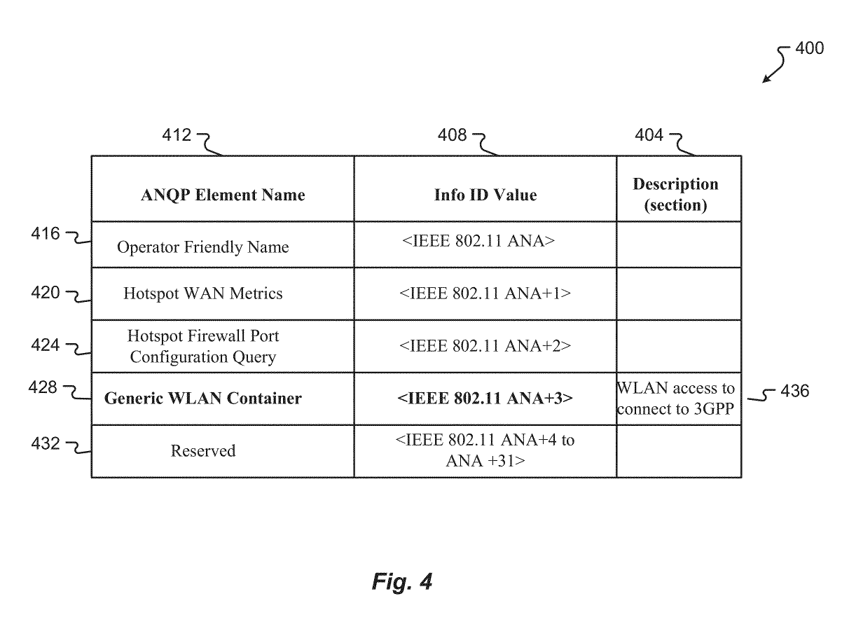

FIG. 4 is an exemplary embodiment of an ANQP Protocol Information ID Definitions table 400. IEEE 802.11 ANA (Assigned Numbers Authority) has allocated a block of 32 ANQP Information IDs that are assigned to new ANQP elements as defined in ANQP Protocol Information ID Definitions table 400. This table provides the ANQP Element Name 412, the Information ID Value 408 and a Description 404. Some of the new ANQP elements include: Operator Friendly Name 416 with Information ID=IEEE 802.11 ANA, Hotspot WAN Metrics 420 with Information ID=IEEE 802.11 ANA+1, Hotspot Firewall Port Configuration Query 424 with Information ID=IEEE 802.11 ANA+2, Generic WLAN Container 428 with Information ID=IEEE 802.11 ANA+3 and Description as WLAN access to connect to 3GPP 436, and Reserved 432 with Information ID=IEEE 802.11 ANA+4 to ANA+31.

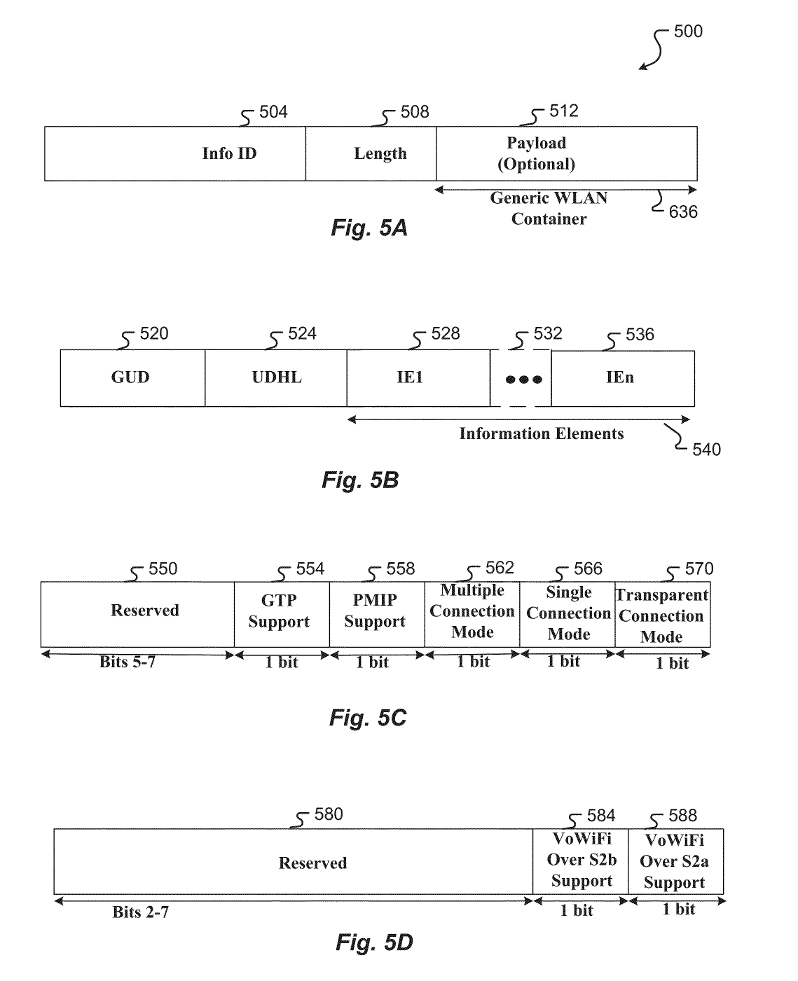

Generic WLAN Container 428 is the ANQP element that contains the information which allows the WLAN access network to connect to the 3GPP Enhanced Packet Core (EPC). The Generic WLAN Container 428 also contains information regarding S2a connectivity modes, options/modes available for connectivity, etc. Further details regarding the Generic WLAN Container 428 are described below and in conjunction with FIG. 5A to 5D. Reserved 432 corresponds to the 27 reserved ANQP elements for possible future use.

FIG. 5A is an exemplary embodiment of the format of an ANQP element format 500. The ANQP element format 500 can contain Info ID field 504, Length field 508 and optional Payload field 512. The Info ID field 504 is a field which contains the ANQP element Information ID Value 408. This Information ID Value 408 as described above and in conjunction with FIG. 4 can vary in value based on the ANQP element. For example, Information ID Value 408=IEEE 802.11 ANA +3 corresponds to Generic WLAN Container 428. The Length field 508 is a 2-octect field corresponding to the length of the Payload field 512. The Payload field 512 can be a generic container whose contents are specified by 3GPP standards. As an example, the Payload field 512 can be a Generic WLAN Container 428 as mentioned above and in conjunction with FIG. 4 and whose format is described below and in conjunction with FIGS. 5B through 5D.

FIG. 5B is an exemplary embodiment of Generic WLAN Container 428. The Generic WLAN Container 428 contains information which allows a WLAN access network to connect to the 3GPP Enhanced Packet Core (EPC). This information includes details such as S2a connectivity mode options, voice over Wi-Fi options, etc. An exemplary format of the Generic WLAN Container 428 is shown in FIG. 5B. Currently most containers have a Generic User Data (GUD) field 520 which indicates the protocol version of the generic container. In general, the GUD filed is an octave, with eight 00000000 for Version 1 and octaves 00000001 to 11111111 Reserved. The Generic WLAN Container 428 also contains a User Data Header Length (UDHL) field 524. The UDHL field 524 indicates the number of octaves after the UDHL, that are in the generic container. Following the UDHL field 524, fields 528-536 are fields available for the different information elements as exemplified by IE1 field 528 through IEn field 536 in 540. As an example, IE1 field 528 can be an information element that identifies the S2a connectivity modes. As another example, IE30 field can correspond to an IE that identifies S2b connectivity support. Yet in another example, an IE with Voice over Wi-Fi support can be indicated in IEn field 536. Notice that information element field 540 corresponds to IE1 field 528 to IEn field 536 and all IEs in-between 532. An exemplary information element field 540 is depicted below in FIG. 5C.

Specifically, FIG. 5C is an exemplary embodiment of an information element with S2a connectivity capability and corresponding modes available. In general, the information element will span one octet, in which information such as GPRS Tunneling Protocol (GTP) Support 554, Proxy Mobile IP (PMIP) Support 558 and S2a connectivity modes support is transmitted. GTP Support 554 provides information to the wireless device 104 as to whether the GTP protocol is supported by the system which enables the network, such as but not limited to General System for Mobile Communications (GSM), Universal Mobile Telecommunications System (UMTS), Long Term Evolution (LTE), to carry General Packet Radio Service (GPRS). PMIP Support 558 would notify the mobile device 104 of that PMIP protocol support is available which would provide access to technologies such as but not limited to, WIMAX, 3GPP, and WLAN.

The wireless device 104 can also be provided with information regarding support to one or more of the S2a connectivity modes. These modes include Multiple Connection Mode, Single Connection Mode, and Transparent Single Connection Mode, which are supported if their corresponding the fields (i.e. 562, 566, and/or 570) is enabled. Reserve field 550 includes reserved bits 5-7 as designated by the standard.

Transparent Single Connection Mode 566 support includes a communication mode between a user equipment (UE) or wireless device 104 and a Trusted WLAN Access Network (TWAN) where the TWAN may set up a non-seamless WLAN offload or an S2a tunnel without explicit request from the wireless device 104. Single Connection Mode 566 corresponds to support of a communication mode that is capable of supporting only a single connection at a time between the wireless device 104 and the TWAN. This connection can be used either for Non-Seamless WLAN Offload (NSWO) or for Packet Data Network (PDN) connectivity. Single connection mode use and the associated parameters of the connection, such as but not limited to NSWO, PDN, etc., can be negotiated during the authentication over a TWAN. Multiple Connection Mode 562 support provides a communication mode that is capable of supporting a single or a multiple connection at a time between a wireless device 104 and a Trusted WLAN Access Network. One connection can be used for non-seamless WLAN offload and one or more simultaneous connections can be used for PDN. The use of the multi-connection mode can be negotiated during authentication over the TWAN and the requested PDN connection which can be set up with a Wireless Link Control Protocol (WLCP) for PDN connectivity.

FIG. 5D is an exemplary embodiment of an information element format for an IE with Voice over Wi-Fi (VoWiFi) support. As was the case with FIG. 5C, information element with VoWiFi will also span 8 bits of data. Reserved bits 2-7 are included in Reserve field 580, while VoWiFi support is contained in bits 0-1. As an example, bit location 1, can include a VoWiFi over S2b Support field 584 which, if enabled can provide VoWiFi support over an S2b interface. As another example, VoWiFi Over S2a Support field 588 can be used to indicate if VoWiFi support is available using an S2a interface. In general, the Voice over WiFi information element can be used to determine if certain applications are supported over S2a, S2b or both interfaces. As described above and in conjunction with FIG. 5A-5D, the generic container can include various information elements and it is not restricted to S2a interface connectivity or VoWiFi, information elements can include other network capabilities available such as, but not limited to S2b interface connectivity.

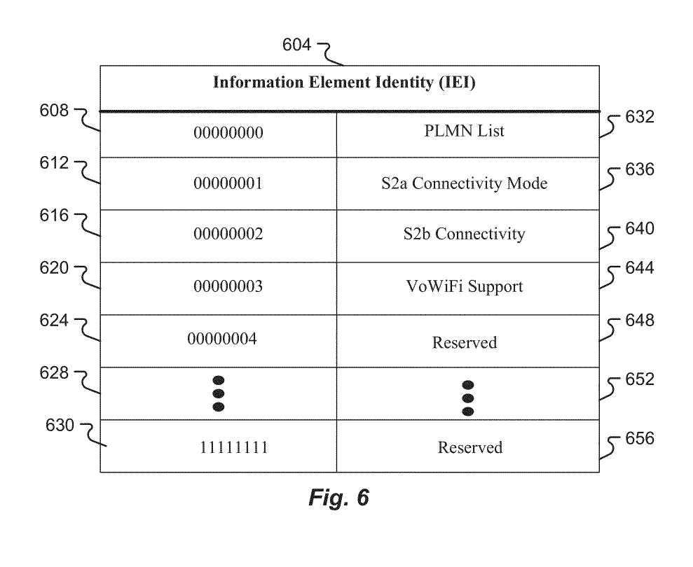

FIG. 6 illustrates an exemplary embodiment of an Information Element Identity table 604 for listings of various information elements that are available in a generic container as described above and in conjunction with FIGS. 5A through 5D. The Information Element Identity table 604 provides some examples of IEIs that could reside in Information Element field 540 in FIG. 5B above. Various IEs are listed ranging from Public Land Mobile Network (PLMN) List 632 to Reserved fields 656 with corresponding identifiers ranging from 608-630. For example, identifier 00000000 in field 608 can represent support for the PLMN network and indicate PLMNs that can be selected from in the WLAN and are identified as PLMN List information element 632. Another information element could be identified as 00000001 in field 612 with corresponding information element 636 indicating S2A connectivity mode support. This information element can further identify the different modes that are available for connection as described above and in conjunction with FIGS. 5A through 5C. Information element in field 616 identified as 00000002 can be used to show the availability information element in field 640 with S2b interface support. Similarly, the information element field 644 can be use to indicate VoWiFi support specified by information element identifier field 620 as 00000003. This information element can further include the interface available for the connection whether it be S2a, S2b or both, as described above and in conjunction with FIG. 5D. Additional Information Element identifiers are available in fields 624-628 (i.e. 00000004-11111111) which are reserved for future use as indicated by the Reserved information element 648-656 with ellipses 628,652 indicating the fields available in between.

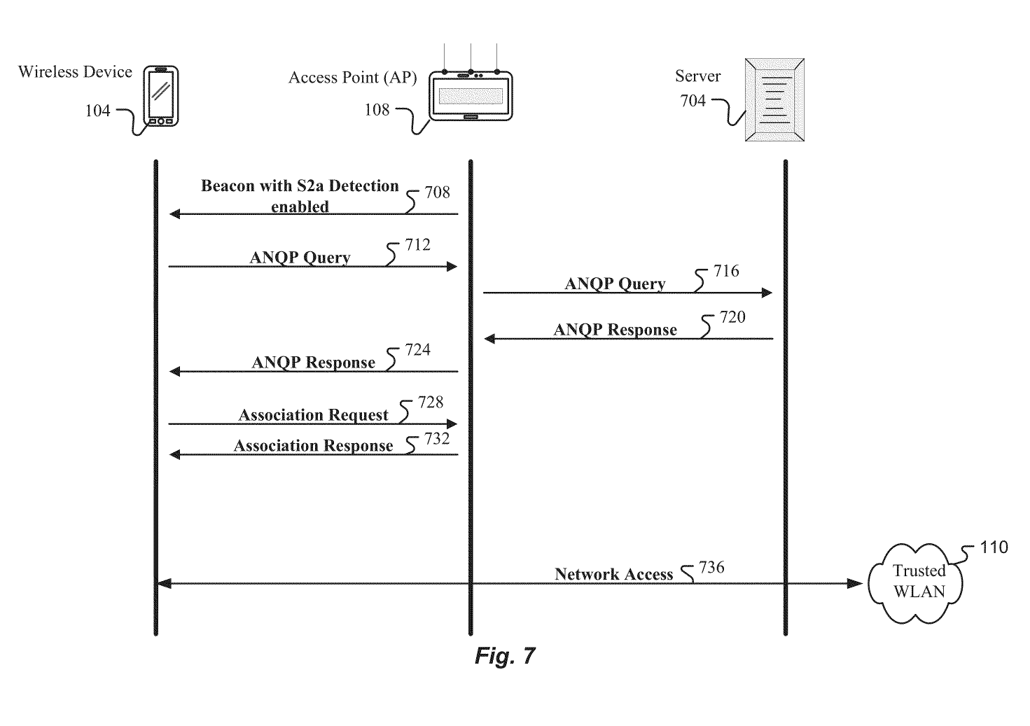

An exemplary embodiment of a fence post diagram illustrating the message flow in a network access system is presented in FIG. 7. In the pre-association process between a wireless device 104 with S2a Mode Connectivity capability and an access point 108, the wireless device 104 must first be within radio range or within the geo-fence of the hotspot or access point 108. The wireless device 104 receives a beacon 708 from access point 108. The beacon 708 will indicate whether the AP 108 provides support for the corresponding protocol in use and provides the Wi-Fi network name or SSID. In addition, the beacon 708 will indicate whether it contains S2a mode selection capability. In one example, the beacon can also include a listing of the modes available to connect (i.e., transparent, single connection and/or multi-connection mode). Other information including network capability, venue specific information, network information, etc., can also be provided in the beacon.

Next, the Wi-Fi network corresponding to the AP 108 advertises the availability of S2a Mode Selection. In response to the beacon information provided, a wireless device 104 will query the AP 108 using Access Network Query Protocol (ANQP) 712 to obtain information useful for the wireless device 104 to connect with the AP 108. The ANQP query, as described herein and as previously described in more detail above and in conjunction with FIGS. 4-6, is a query and response protocol that is generally used by Wi-Fi hotpots to provide the services offered by the AP 108 to other wireless devices 104. For example, in ANQP Response 720, 724, the wireless device 104, can obtain information like, but not limited to, the capabilities of the network, the connectivity modes available, and other pertinent information for the wireless device 104 from a server 704. S2a mode selection capability is not restricted to the beacon, as mentioned herein, the ANQP query/response mechanism can also be used to obtain information regarding connectivity mode capability and modes available for connection. In one embodiment, as part of the ANQP query command, the wireless device 104 can send in the User ID 712 associating the user to the access point 108 which routes 716 this information to the server 704. The User ID can be a string that can be provisioned on the wireless device 104 when it associates with the AP 108 and indicates its preferences. The routing between the wireless device 104, AP 108 and the server 704 is seen in FIG. 7, with the router or AP 108 acting as a medium by which the devices, such as but not limited to, wireless device 104 and server 704 on the network, can communicate.

In one embodiment, the server 704 provides an ANQP response 720 through the AP 108 which is then routed in 724 from the AP 108 to the wireless device 104. The ANQP response from the AP 108 to the wireless device 104 includes information specific to the services provided, such as connectivity using VoWiFi and/or support using S2a, S2b interface, or both. For example, the server 704, based on the information obtained from the wireless device 104, can send options available to the user specific to the capabilities of both the network and the wireless device 104.

Once the ANQP response is obtained in 724 by the wireless device 104, the wireless device 104 can optionally place an association request 728 and obtain an association response 732 with the identified access point 108. Upon association, the wireless device 104 obtains network access in 736 to a Trusted WLAN 110. The network access to the TWAN, as previously mentioned and described in conjunction with FIGS. 5A-5D, can then connect using GTP or PMIP tunnelling, as specified by the information element(s) contained within the Generic WLAN container 428.

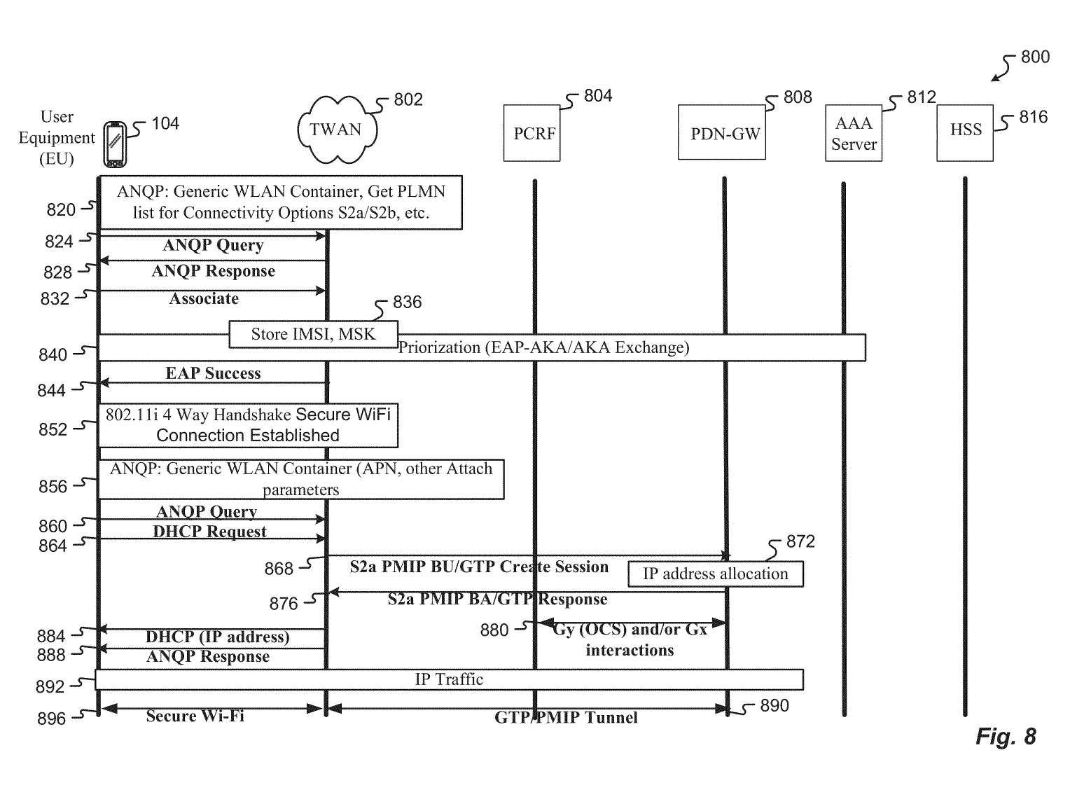

FIG. 8 is an exemplary fence post diagram showing a trusted attachment between a wireless device 104 and WLAN and components of a 3GPP EPC. As illustrated in FIG. 8, various components participate in the connection between a wireless device 104 operating under 3GPP and a WLAN under IEEE 802.11 protocol. The main components include, but are not limited to: the wireless device 104, the Trusted WLAN Access Network (TWAN) 802, Policy and Charging Rules Function (PCRF) 804, Packet Data Network—Gateway (PDN-GW) 808, Authentication, Authorization and Accounting (AAA) Server 812, and Home Subscriber Server (HSS) 816.

To initiate attachment, the ANQP Query/Response mechanism begins in operation 824 and 828, which exchanges information between a wireless device 104 and a server 704. The information exchanged during the ANQP Query/Response 824, 828, includes, but is not limited to, the Generic WLAN Container 428, listings of PLMNs that are available for communication and connectivity options such as S2a, S2b, etc., as illustrated by 820. Alternatively, other means for communicating such information are available. One example is a beacon frame transmission, where the WLAN network can advertise through 802.11 beacons the S2a connectivity options supported. Another example is through probe response, where the wireless device can obtain the connectivity options and other information through an IEEE 802.11 probe request and response. Details on the contents of the Generic WLAN Container 428 can be specified by network communication specifications such as IEEE 802.11 standard. In addition, exemplary contents and formatting is described in more detail above and in conjunction with FIGS. 5A-5D.

Based on the information received by the query and response in 824, 828 the association command and operation 832 take place between the wireless device 104 and a TWAN 802. The operation proceeds to the Authentication, Authorization, and Accounting (AAA) Server 812 where authentication and accounting occurs between the wireless device 104, the WLAN 802 and the rest of the 3GPP Evolved Packet Core (3GPP EPC) system. For example in operation 836, TWAN 802 aids in storing key material, such as Master Session Key (MSK) and the International Mobile Subscriber Identifier (IMSI), which are used to ensure a secure communication within the network and with the authenticated wireless device 104.

In addition, concurrently or separately, prioritization occurs in step 840. Prioritization can include for example, the security exchange between the IEEE 802.11 and the 3GPP entity. The security exchange can include an EAP request/identity sent by the wireless device 104 to the WLAN and in response the WLAN transmits an EAP response. The exchange can further include the AAA server 812, who obtains the Extensible Authentication Protocol-Authentication and Key Agreement (EAP-AKA), and sends an EAP success message to the WLAN 802.

In operation 844, the TWAN 802 informs the wireless device 104 of the successful authentication within an EAP success message. In operation 852, the TWAN 802 and the user equipment 104 perform a 4-way handshake per 802.11 security procedure. At that point, another ANQP Query/Response exchange can occur between the wireless device 104 and server 704 where additional information can be transmitted or received in 860 and 888, respectively. Parameters included in this second ANQP exchange can include other Generic WLAN Container 428 parameters such as Access Point Name (APN), PDN type, and other attachment parameters.

Alternatively the network information exchange between the wireless device 104 and the trusted wireless access network 802, in operation 864 and 884, can be achieved using other communication protocols such as a (Dynamic Host Configuration Protocol) DHCP request and response or even an EAP request. In using a DHCP, the additional parameters may be sent in a DHCP request message as in operation 864. Note that with the DHCP request 884 an ANQP query 860 or ANQP response 888 may not be necessary. Therefore, there exists, at least two options to obtaining parameters such as an IP address: 1) ANQP Query/Response 860, 888 and/or 2) DHCP Request/Response 864, 884.

Next, in operation 868 the IP connectivity established operations may result in a wireless and access network 802 extending an IP request (IP address allocation 872) to the (Packet Data Network Gateway (PDN-GW) 808. The TWAN for example, can send a binding message to the PDN-GW 808 detailing whether to establish a session that is GTP or PMIP based, according to the S2a session and whether it is GTP or PMIP based. By operation 876, the PDN-GW 808 will send an acknowledgement message. Upon successful attachment and connection between the TWAN 802 and the wireless device is established, the wireless device 104 may can and receive IP traffic in operation 892 over the trust WLAN link with the WLAN access network 802 and use the established PMIP-GTP tunnel 890 to communicate further with the 3GPP EPC network using the secure Wi-Fi 896.

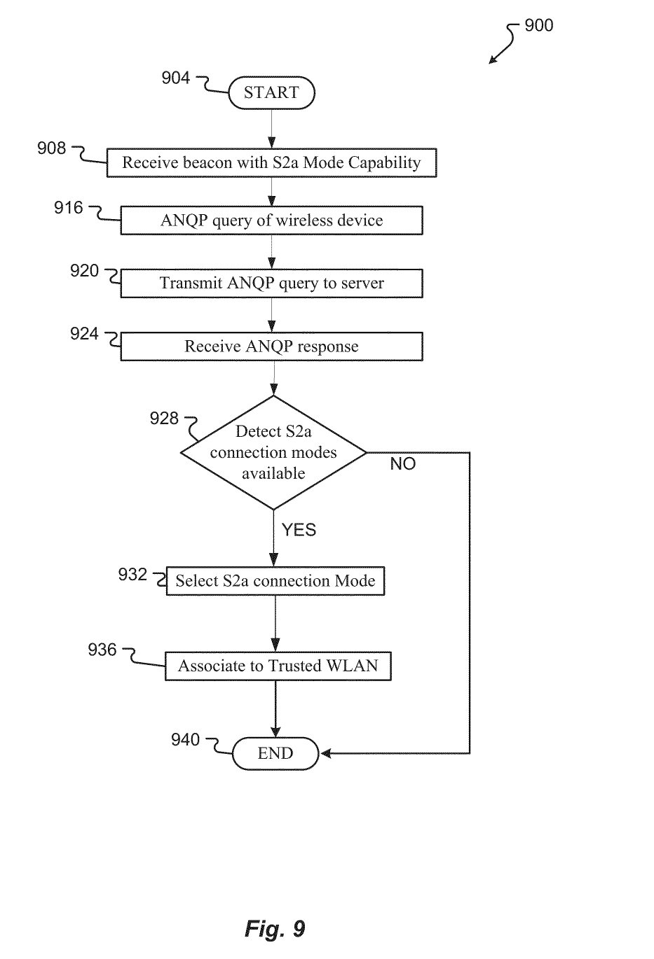

FIG. 9 outlines an exemplary flowchart illustrating trusted WLAN association. In particular, association begins at step 904 and continues to step 908. In step 908 a beacon is received with S2a mode capability at a wireless device 104. Once the beacon is received and the wireless device has the option of selecting between the various S2a modes, then the wireless device can respond with an ANQP query at step 916. The ANQP query as explained above includes information about the wireless device as well as the selection of the S2a mode capability based on the options available and provided by beacon in step 908. In addition or alternately, the S2a mode capabilities can be introduced during the ANQP Query/Response exchange or other similar discovery service. Details regarding the ANQP Generic WLAN container and related information elements are described above in further detail and in conjunction with FIG. 5A-5D.

The process then continues to step 920 where ANQP query from the wireless device is transmitted to server 704 from the wireless device 104. The wireless device 104 receives this ANQP response from the server 704 in step 924. The response from the server 704 will include information regarding the association with the Trusted WLAN along with the corresponding S2a mode that was previously selected. If various S2a modes are available, then the user or the wireless device 104 can select the S2a mode corresponding to the best mode available to the wireless device for a more optimal operation. If there is no selection mode available then the selection process ends at step 940. However, if an S2a mode is detected at Step 928, the process continues to Step 932 where an S2a mode is selected. Once selected the process and association continues to step 936 where the association occurs with the TWAN using the selected connectivity mode. Once the association is complete, then the process ends at step 940.

Aspects are thus directed toward a wireless device for receiving frames, comprising: a memory; a processor; a transceiver, the transceiver prior to associating with a network configured to: receive a beacon frame with trusted wireless network access information, wherein the beacon frame includes an information element indicating S2a support; transmit a service query with device specific information and request for a plurality of information elements; and receive a query response in response to the transmitted service query, wherein the query response includes a generic wireless local area network (WLAN) container, wherein the generic WLAN container includes information regarding S2a connectivity modes. Aspects of the above wireless device include wherein the S2a connectivity modes include at least one of a transparent single-connection mode, a single connection mode and a multi-connection mode, and wherein the transparent single-connection mode can support a non-seamless WLAN offload without an explicit request from the transceiver. Aspects of the above wireless device include wherein the single connection mode can support the non-seamless WLAN offload or a packet data network offload, and wherein the multi-connection mode can support one or more connections using the non-seamless WLAN offload and the packet data network offload. Aspects of the above wireless device include wherein the generic WLAN container includes the information element indicating Voice over WiFi (VoWiFi) support. Aspects of the above wireless device include wherein the generic WLAN container includes the information element indicating S2b support. Aspects of the above wireless device further comprising selecting at least one of the S2a connectivity modes for attachment to a WLAN. Aspects of the above wireless device include wherein the transceiver is operating in accordance with 3^{rd} Generation Partnership Project (3GPP) network protocol.

Embodiments include a method for connecting to a wireless local area network, the method comprising: receiving, by a transceiver prior to associating with a network, a beacon frame with trusted wireless network access information, wherein the beacon frame includes an information element indicating S2a support; transmitting, by the transceiver, a service query with device specific information and request for a plurality of information elements; and receiving, by the transceiver, a query response in response to the transmitted service query, wherein the query response includes a generic wireless local area network (WLAN) container, wherein the generic WLAN container includes information regarding S2a connectivity modes. Aspects of the method above further comprising selecting at least one of the S2a connectivity modes for attachment to a WLAN. Aspects of the method above include wherein the S2a connectivity modes include at least one of a transparent single-connection mode, a single connection mode and a multi-connection mode, and wherein the transparent single-connection mode can support a non-seamless WLAN offload without an explicit request from the transceiver. Aspects of the method above include wherein the single connection mode can support the non-seamless WLAN offload or a packet data network offload, and wherein the multi-connection mode can support one or more connections using the non-seamless WLAN offload and the packet data network offload. Aspects of the method above include wherein the information regarding S2a connectivity modes further includes information regarding General Packet Radio Service (GPRS) Tunneling Protocol support. Aspects of the method above include wherein the information regarding S2a connectivity modes further includes information regarding Proxy Mobile Internet Protocol support. Aspects of the method above include wherein the generic WLAN container includes the information element indicating Voice over WiFi (VoWiFi) support. Aspects of the method above include wherein the information element indicating the VoWiFi support can further indicate one or more of S2a and S2b support. Aspects of the method above include wherein the transceiver is operating in accordance with 3^{rd} Generation Partnership Protocol (3GPP) network protocol.

Embodiments include a non-transitory computer readable medium having instructions thereon that when executed by at least one processor of a wireless device perform a method comprising: receiving, by a transceiver prior to associating with a network, a beacon frame with trusted wireless network access information, wherein the beacon frame includes an information element indicating S2a support; transmitting, by the transceiver, a service query with device specific information and request for a plurality of information elements; and receiving, by the transceiver, a query response in response to the transmitted service query, wherein the query response includes a generic wireless local area network (WLAN) container, wherein the generic WLAN container includes information regarding S2a connectivity modes. Aspects of the media above include wherein the S2a connectivity modes include at least one of a transparent single-connection mode, a single connection mode and a multi-connection mode, and wherein the transparent single-connection mode can support a non-seamless WLAN offload without an explicit request from the transceiver. Aspects of the media above include wherein the single connection mode can support the non-seamless WLAN offload or a packet data network offload, and wherein the multi-connection mode can support one or more connections using the non-seamless WLAN offload and the packet data network offload. Aspects of the media above include wherein the generic WLAN container includes the information element indicating Voice over WiFi (VoWiFi) support. Aspects of the media above include wherein the information element indicating the VoWiFi support can further indicate one or more S2a and S2b support.

Embodiments include a system comprising: means for receiving prior to associating with a network, a beacon frame with trusted wireless network access information, wherein the trusted wireless network access information includes an information element indicating S2a support; means for transmitting a service query with device specific information and request for a plurality of information elements; and means for receiving a query response in response to the transmitted service query, wherein the query response includes a generic wireless local area network (WLAN) container, wherein the generic WLAN container includes information regarding S2a connectivity modes. Aspects of the system include wherein the S2a connectivity modes include at least one of a transparent single-connection mode, a single connection mode and a multi-connection mode, and wherein the transparent single-connection mode can support a non-seamless WLAN offload without an explicit request from the transceiver. Aspects of the system include wherein the single connection mode can support the non-seamless WLAN offload or a packet data network offload, and wherein the multi-connection mode can support one or more connections using the non-seamless WLAN offload and the packet data network offload. Aspects of the system include wherein the generic WLAN container includes the information element indicating Voice over WiFi (VoWiFi) support. Aspects of the system above further comprising selecting at least one of the S2a connectivity modes for attachment to a WLAN. Aspects of the system above include wherein the information regarding S2a connectivity modes further includes information regarding General Packet Radio Service (GPRS) Tunneling Protocol Support and Proxy Mobile Internet Protocol support.

The exemplary embodiments are described in relation to connecting to a Trusted WLAN using an S2a interface. However, it should be appreciated, that in general, the systems and methods herein will work equally well for any type of communication system in any environment utilizing any one or more protocols including wired communications, wireless communications, powerline communications, coaxial cable communications, fiber optic communications and the like.

The exemplary systems and methods are described in relation to IEEE 802.11 transceivers and associated communication hardware, software and communication channels. However, to avoid unnecessarily obscuring the present disclosure, the following description omits well-known structures and devices that may be shown in block diagram form or otherwise summarized.

For purposes of explanation, numerous details are set forth in order to provide a thorough understanding of the present embodiments. It should be appreciated however, that the techniques herein may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a communications network and/or the Internet, or within a dedicated secure, unsecured and/or encrypted system. Thus, it should be appreciated that the components of the system can be combined into one or more devices, such as an access point or station, or collocated on a particular node/element(s) of a distributed network, such as a telecommunications network. As will be appreciated from the following description, and for reasons of computational efficiency, the components of the system can be arranged at any location within a distributed network without affecting the operation of the system. For example, the various components can be located in a transceiver, an access point, a station, a management device, or some combination thereof. Similarly, one or more functional portions of the system could be distributed between a transceiver, such as an access point(s) or station(s) and an associated computing device.

Furthermore, it should be appreciated that the various links, including communications channel(s), connecting the elements (which may not be not shown) can be wired or wireless links, or any combination thereof, or any other known or later developed element(s) that is capable of supplying and/or communicating data and/or signals to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

While the above-described flowcharts have been discussed in relation to a particular sequence of events, it should be appreciated that changes to this sequence can occur without materially effecting the operation of the embodiment(s). Additionally, the exact sequence of events need not occur as set forth in the exemplary embodiments, but rather the steps can be performed by one or the other transceiver in the communication system provided both transceivers are aware of the technique being used for initialization. Additionally, the exemplary techniques illustrated herein are not limited to the specifically illustrated embodiments but can also be utilized with the other exemplary embodiments and each described feature is individually and separately claimable.

The above-described system can be implemented on a wireless telecommunications device(s)/system, such an 802.11 transceiver, or the like. Examples of wireless protocols that can be used with this technology include 802.11a, 802.11b, 802.11g, 802.11n, 802.11ac, 802.11ad, 802.11af, 802.11ah, 802.11ai, 802.11aj, 802.11aq, 802.11ax, 802.11u, WiFi, LTE, LTE Unlicensed, 4 G, Bluetooth®, WirelessHD, WiGig, 3GPP, Wireless LAN, WiMAX.

The term transceiver as used herein can refer to any device that comprises hardware, software, firmware, or combination thereof and is capable of performing any of the methods described herein.

Additionally, the systems, methods and protocols can be implemented on one or more of a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a modem, a transmitter/receiver, any comparable means, or the like. In general, any device capable of implementing a state machine that is in turn capable of implementing the methodology illustrated herein can be used to implement the various communication methods, protocols and techniques according to the disclosure provided herein.

Examples of the processors as described herein may include, but are not limited to, at least one of Qualcomm® Snapdragon® 800 and 801, Qualcomm® Snapdragon® 610 and 615 with 4 G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with the embodiments is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed methods may be readily implemented in software and/or firmware that can be stored on a storage medium, executed on programmed general-purpose computer with the cooperation of a controller and memory, a special purpose computer, a microprocessor, or the like. In these instances, the systems and methods can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

It is therefore apparent that there has been provided systems and methods for S2a connectivity for Wi-Fi based technologies. While the embodiments have been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this disclosure.

1. A wireless device, comprising:
a memory;
a processor;
a transceiver, the transceiver prior to associating with a network configured to:
receive a beacon frame with trusted wireless network access information, wherein the beacon frame includes an information element indicating S2a support;
transmit a service query with device specific information and request for a plurality of information elements; and
receive a query response in response to the transmitted service query, wherein the query response includes a generic wireless local area network (WLAN) container, wherein the generic WLAN container includes information regarding S2a connectivity modes.

2. The wireless device of claim 1, wherein the S2a connectivity modes include at least one of a transparent single-connection mode, a single connection mode and a multi-connection mode, and wherein the transparent single-connection mode can support a non-seamless WLAN offload without an explicit request from the transceiver.

3. The wireless device of claim 2, wherein the single connection mode can support the non-seamless WLAN offload or a packet data network offload, and wherein the multi-connection mode can support one or more connections using the non-seamless WLAN offload and the packet data network offload.

4. The wireless device of claim 1, wherein the generic WLAN container includes the information element indicating Voice over WiFi (VoWiFi) support.

5. The wireless device of claim 1, wherein the generic WLAN container includes the information element indicating S2b support.

6. The wireless device of claim 1, further comprising selecting at least one of the S2a connectivity modes for attachment to a WLAN.

7. The wireless device of claim 1, wherein the transceiver is operating in accordance with 3^{rd} Generation Partnership Project (3GPP) network protocol.

8. A method comprising:
receiving, by a transceiver prior to associating with a network, a beacon frame with trusted wireless network access information, wherein the beacon frame includes an information element indicating S2a support;
transmitting, by the transceiver, a service query with device specific information and request for a plurality of information elements; and
receiving, by the transceiver, a query response in response to the transmitted service query, wherein the query response includes a generic wireless local area network (WLAN) container, wherein the generic WLAN container includes information regarding S2a connectivity modes.

9. The method of claim 8, further comprising selecting at least one of the S2a connectivity modes for attachment to a WLAN.

10. The method of claim 9, wherein the S2a connectivity modes include at least one of a transparent single-connection mode, a single connection mode and a multi-connection mode, and wherein the transparent single-connection mode can support a non-seamless WLAN offload without an explicit request from the transceiver.

11. The method of claim 10, wherein the single connection mode can support the non-seamless WLAN offload or a packet data network offload, and wherein the multi-connection mode can support one or more connections using the non-seamless WLAN offload and the packet data network offload.

12. The method of claim 10, wherein the information regarding S2a connectivity modes further includes information regarding General Packet Radio Service (GPRS) Tunneling Protocol support.

13. The method of claim 10, wherein the information regarding S2a connectivity modes further includes information regarding Proxy Mobile Internet Protocol support.

14. The method of claim 8, wherein the generic WLAN container includes the information element indicating Voice over WiFi (VoWiFi) support.

15. The method of claim 8, wherein the information element indicating the VoWiFi support can further indicate one or more of S2a and S2b support.

16. The method of claim 8, wherein the transceiver is operating in accordance with 3^{rd} Generation Partnership Protocol (3GPP) network protocol.

17. A non-transitory computer readable medium having instructions thereon that when executed by at least one processor of a wireless device perform a method comprising:
receiving, by a transceiver prior to associating with a network, a beacon frame with trusted wireless network access information, wherein the beacon frame includes an information element indicating S2a support;
transmitting, by the transceiver, a service query with device specific information and request for a plurality of information elements; and
receiving, by the transceiver, a query response in response to the transmitted service query, wherein the query response includes a generic wireless local area network (WLAN) container, wherein the generic WLAN container includes information regarding S2a connectivity modes.

18. The non-transitory medium of claim 17, wherein the S2a connectivity modes include at least one of a transparent single-connection mode, a single connection mode and a multi-connection mode, and wherein the transparent single-connection mode can support a non-seamless WLAN offload without an explicit request from the transceiver.

19. The non-transitory medium of claim 18, wherein the single connection mode can support the non-seamless WLAN offload or a packet data network offload, and wherein the multi-connection mode can support one or more connections using the non-seamless WLAN offload and the packet data network offload.

20. The non-transitory medium of claim 17, wherein the generic WLAN container includes the information element indicating Voice over WiFi (VoWiFi) support, and wherein the information element indicating the VoWiFi support can further indicate one or more S2a and S2b support.
